(19) United States
(12) Patent Application Publication
(10) Pub. No.: US 2007/0236751 A1
(43) Pub. Date: Oct. 11, 2007

(54) Image display device

(75) Inventor: Fumio Nagasaka, Ueda City (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/728,597

(22) Filed: Mar. 26, 2007

(30) Foreign Application Priority Data
Mar. 27, 2006 (JP) 2006-085995
Jan. 30, 2007 (JP) 2007-018982

(51) Int. Cl. G06T 1/00; H04N 1/32

(52) U.S. Cl. 358/442; 345/418

(57) ABSTRACT

An image display device for displaying a plurality of original images aligned in a specified sequence is provided. The image display device comprises a display unit, a display control module, and a user interface. The display control module control the display unit to display a display image of an original image selected among the plurality of images while changing the image selection according to the specified sequence. The user interface unit allows a user to perform operations for changing the image selection. A plurality of changing speed levels are correlated to the operation of the user interface unit. The display control module uses a plurality of speed correlated images correlated respectively to the plurality of changing speed levels as the display images to be displayed on the display unit for each of the plurality of original images. The speed correlated images are constructed such that higher-speed correlated images correlated to higher changing speed levels are displayed in a shorter time.

### CROSS-REFERENCE TO RELATED APPLICATIONS

The present application claims the priority based on Japanese Patent Applications No. 2006-85995 filed on Mar. 27, 2006, and No. 2007-18982 filed on Jan. 30, 2007, the disclosures of which are hereby incorporated by reference in their entireties.

### BACKGROUND OF THE INVENTION

1. Field of the Invention

The present invention relates to a technique for changing and displaying a plurality of images on an image display device.

2. Description of the Related Art

In recent years, as digital still cameras are developed and as the capacity of storage media such as media cards increases, it has become possible to shoot many images using a digital still camera. When printing or displaying a desired image from among the many images taken in this way, the user performs the work of checking each of this plurality of images and specifying an image. Generally, checking these shot images is performed by displaying thumbnail images of each image on a display unit such as a liquid crystal panel, and viewing these thumbnail images. JP2002-374482A, for example, describes a digital still camera for displaying thumbnail images on the liquid crystal panel to select a desired image.

With a device for displaying thumbnail images for selecting a desired image, for example with a printer for displaying thumbnail images on a liquid crystal panel for selecting images subject to printing, the thumbnail images are changed in sequence in the sequence they were shot and displayed on the liquid crystal panel. Then, this kind of printer is typically equipped with a user interface for the user to make instructions regarding the thumbnail image display changing speed and the display direction of descending or ascending order in relation to the sequence in which they were shot.

Here, the image data of the thumbnail images are often compressed using a compression method such as JPEG (Joint Photographic Experts Group). In this case, to display a thumbnail image on the liquid crystal panel, the compressed data must undergo a decompression process. Because of this, even if the user wishes to change the display at a high speed, the actual time at which the thumbnail images are changed in sequence is determined by the time required for the decompression process, and there is the problem that it is difficult to realize high speed of display change.

Also, the problem described above is not limited to printers, but is a problem common to various devices, such as digital still cameras, capable of changing the display of images according to the operation of a user interface.

### SUMMARY OF THE INVENTION

An object of the present invention is to provide a technique for realizing high speed image display changing with an image display device.

According to an aspect of the present invention, there is provided an image display device for displaying a plurality of original images aligned in a specified sequence. The image display device comprises a display unit; a display control module, and a user interface. The display control module control the display unit to display a display image of an original image selected among the plurality of images while changing the image selection according to the specified sequence. The user interface unit allows a user to perform operations for changing the image selection. A plurality of changing speed levels are correlated to the operation of the user interface unit. The display control module uses a plurality of speed correlated images correlated respectively to the plurality of changing speed levels as the display images to be displayed on the display unit for each of the plurality of original images. The speed correlated images are constructed such that higher-speed correlated images correlated to higher changing speed levels are displayed in a shorter time.

With the image display device, since higher-speed correlated images correlated to higher changing speed levels are displayed in a shorter time, the user can control the changing speed of the display images through operation of the user interface unit, thereby realizing faster display changing speed.

Note that the present invention can be realized with various aspects, and for example, it can be realized with aspects such as an image display method, a computer program for realizing the functions of an image display method or and image display device, a recording medium on which is recorded that computer program, data signals realized inside carrier waves containing that computer program, and the like.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is an external view of the printer for which the image display device as an embodiment of the present invention;

FIG. 2 is a block diagram showing the internal structure of the printer;

FIG. 3 schematically shows the state of the displayed images changing according to the operation of the tracking wheel;

FIG. 4 is a flow chart showing the image display process for the first embodiment;

FIG. 5 is an explanatory drawing showing an example of the speed correlated image group generated at step S205;

FIG. 6 is a flow chart showing the details of step S220 shown in FIG. 4;

FIG. 7A shows the correlation between the tracking wheel rotation speed and the speed correlated image change interval;

FIG. 7B shows the correlation between the tracking wheel rotation speed and the speed correlated image data size;

FIG. 8 schematically shows the state of the speed correlated image being displayed on the liquid crystal panel with the first embodiment;

FIG. 9 is a flow chart showing the image display process with the second embodiment;

FIG. 10 is a block diagram showing the internal structure of the printer with the third embodiment;

FIG. 11 schematically shows the speed correlated image generated with the third embodiment; and

FIG. 12 shows the speed correlated image with the fourth embodiment.

### DESCRIPTION OF THE PREFERRED EMBODIMENT

Following, a description is given based on embodiments of preferred aspects for implementing the present invention in the following sequence.

A. First Embodiment

B. Second Embodiment

C. Third Embodiment

D. Fourth Embodiment

E. Variation Examples

### A. First Embodiment

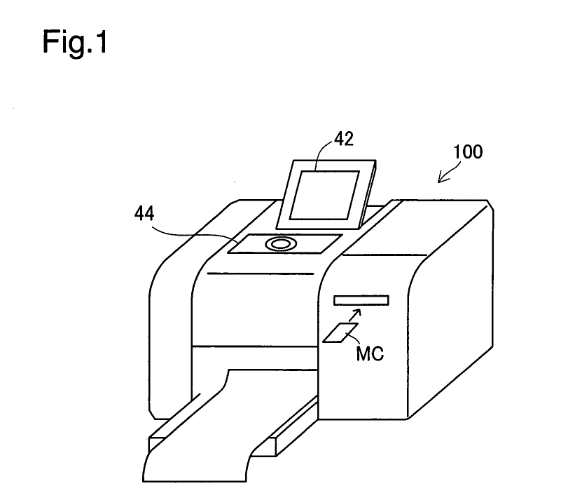

FIG. 1 is an external view of a printer which includes an image display device as an embodiment of the present invention. This printer 100 is equipped with a liquid crystal panel 42 and an operating unit 44, and is able to read and print image data from an inserted media card MC. The liquid crystal panel 42 is able to display thumbnail images stored in the memory card MC and various menu screens. The user can change the image displayed on the liquid crystal panel 42 by operating the operating unit 44 and can select an image subject to printing.

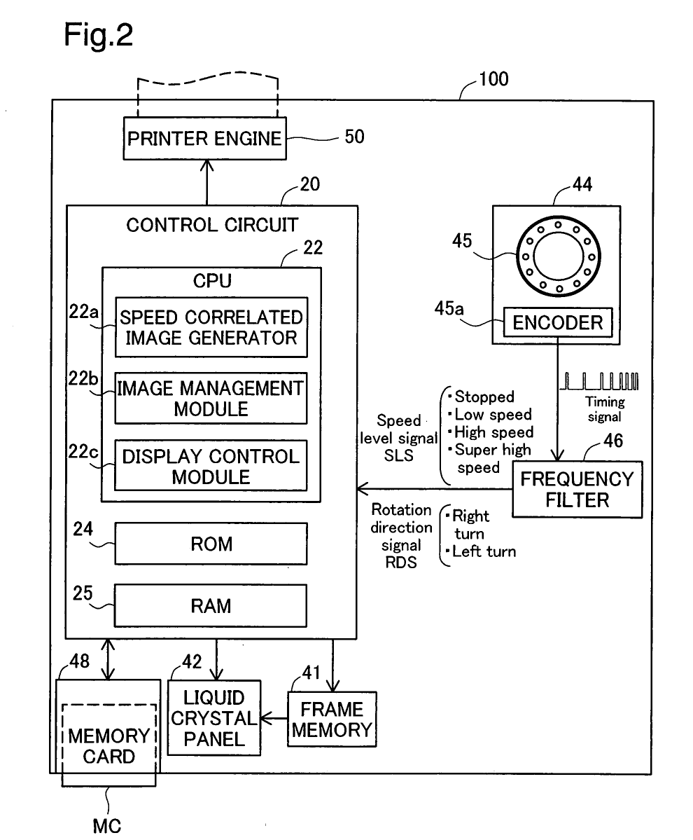

FIG. 2 is a block diagram showing the internal constitution of the printer 100. In addition to the liquid crystal panel 42 and the operating unit 44 described above, the printer 100 is equipped with a control circuit 20, a printer engine 50, a memory card slot 48, a frame memory 41, and a frequency filter 46. The printer engine 50 is equipped with a carriage (not illustrated) in which ink cartridges are incorporated, a motor for driving this carriage, and is a mechanism for executing the actual printing. The frame memory 41 temporarily stores image data of an image being displayed on the liquid crystal panel 42.

The operating unit 44 is equipped with a tracking wheel 45. This tracking wheel 45 is the user interface for specifying the changing direction and the changing speed of the images displayed on the liquid crystal panel 42.

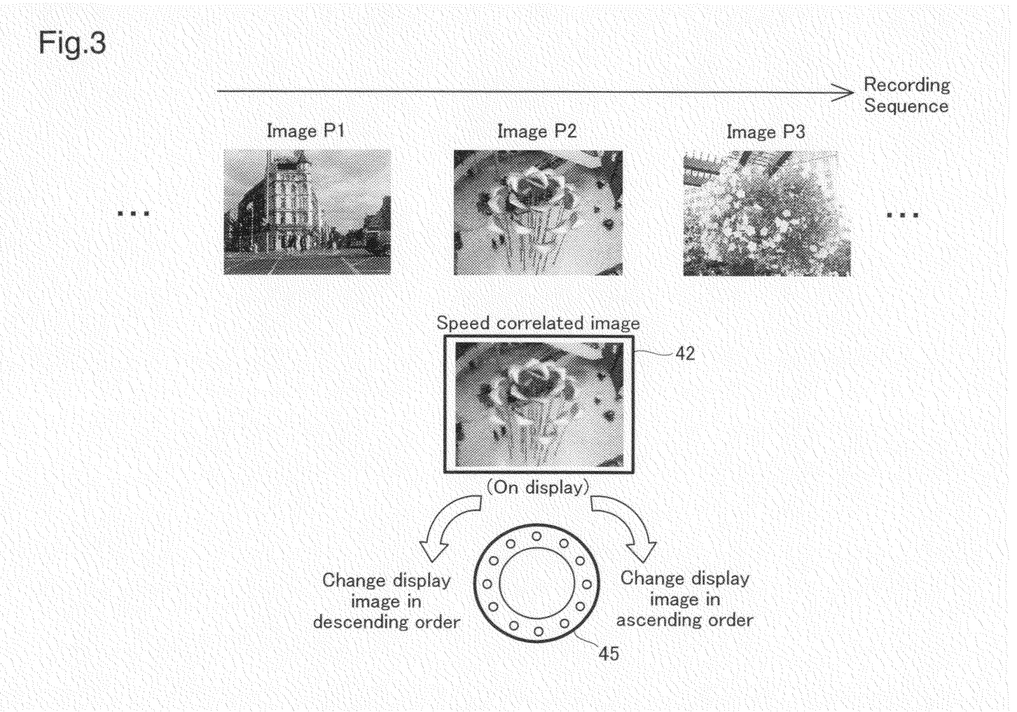

FIG. 3 is an explanatory diagram showing the changing state of the images displayed according to the operation of the tracking wheel 45. In FIG. 3, the three images P1, P2, and P3 of the top part show images stored in the memory card MC, and are aligned in the sequence in which they are recorded in the memory card MC (shot sequence). Here, each image recorded in the memory card MC is stored, for example, as data in the Exif (Exchangeable Image File Format) format including a main image compressed using the JPEG method, and a thumbnail image compressed using the JPEG method (thumbnail compressed images). With this embodiment, a plurality of speed correlated images are generated based on the thumbnail compressed image, and the speed correlated images are displayed in turn according to the operation of the tracking wheel 45.

If the user rotates the tracking wheel 45 to the right when a speed correlated image of the image P2 is displayed on the liquid crystal panel 42, the displayed image changes in ascending sequence, and a speed correlated image of the image P3 is displayed consequently. On the other hand, if the user rotates the tracking wheel 45 to the left, the displayed image changes in descending order, and a speed correlated image of the image P1 is displayed. If the user rotates this tracking wheel 45 more quickly, the images are changed more quickly, and when rotated more slowly, the images are changed more slowly. Specifically, the user can specify the change direction of the displayed images according to the rotation direction of the tracking wheel 45, and can specify the rise and fall of the change speed of the displayed images according to the rotation speed of the tracking wheel 45. Note that the speed correlated images will be described in detail later.

Returning to FIG. 2, the operating unit 44 is equipped with an encoder 45a that outputs frequency timing signals according to the rotation speed of the tracking wheel 45. The frequency filter 46 derives the frequencies of the timing signals output from this encoder 45a, and determines whether the rotation speed corresponding to the derived frequency belongs to any of the levels of the four preset speed levels of “stopped”, “low speed”, “high speed”, and “super high speed”, and sends a speed level signal SLS indicating the determined speed level to the control circuit 20. The frequency filter 46 also determines the rotation direction of the tracking wheel 45 based on the timing signals output from the encoder 45a, and sends a rotation direction signal RDS indicating this rotation direction of left turn or right turn to the control circuit 20.

The control circuit 20 is equipped with a CPU 22, a ROM 24, and a RAM 26. A control program for doing overall control of the operation of the printer 100 is stored in the ROM 24. Then, by executing this control program, the CPU 22 functions as a speed correlated image generator 22a, an image management module 22b, and a display control module 22c.

The speed correlated image generator 22a generates speed correlated images based on a thumbnail image. The image management module 22b selects a speed correlated image to be displayed on the liquid crystal panel 42 (hereafter called simply “display image”) based on the speed level signals SLS and the rotation direction signals RDS output from the frequency filter 46. The display control module 22c controls the liquid crystal panel 42 and displays images based on the image data stored in the frame memory 41.

Note that the combination of the image management module 22b and the display control module 22c correlates to the display control module in the claimed invention, and the operating unit 44 correlates to the user interface unit in the claimed invention, the tracking wheel 45 correlates to the rotating type operating unit in the claims, and the memory card MD correlates to the storage unit in the claimed invention.

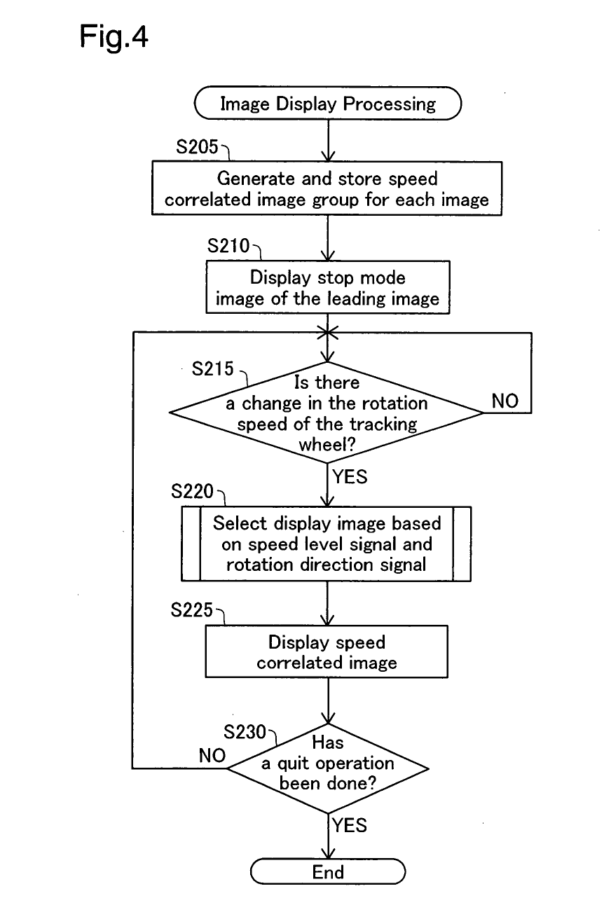

FIG. 4 is a flow chart showing the image display process for the first embodiment. The process is started at the printer 100 in response to the user's operation of the operating unit 44 to select a printing subject image selection menu from a menu screen (not illustrated) displayed on the liquid crystal panel 42.

When the image display process is started, the speed correlated image generator 22a reads all the image data stored in the memory card MC to the RAM 25, and generates a speed correlated image group for each image in step S205.

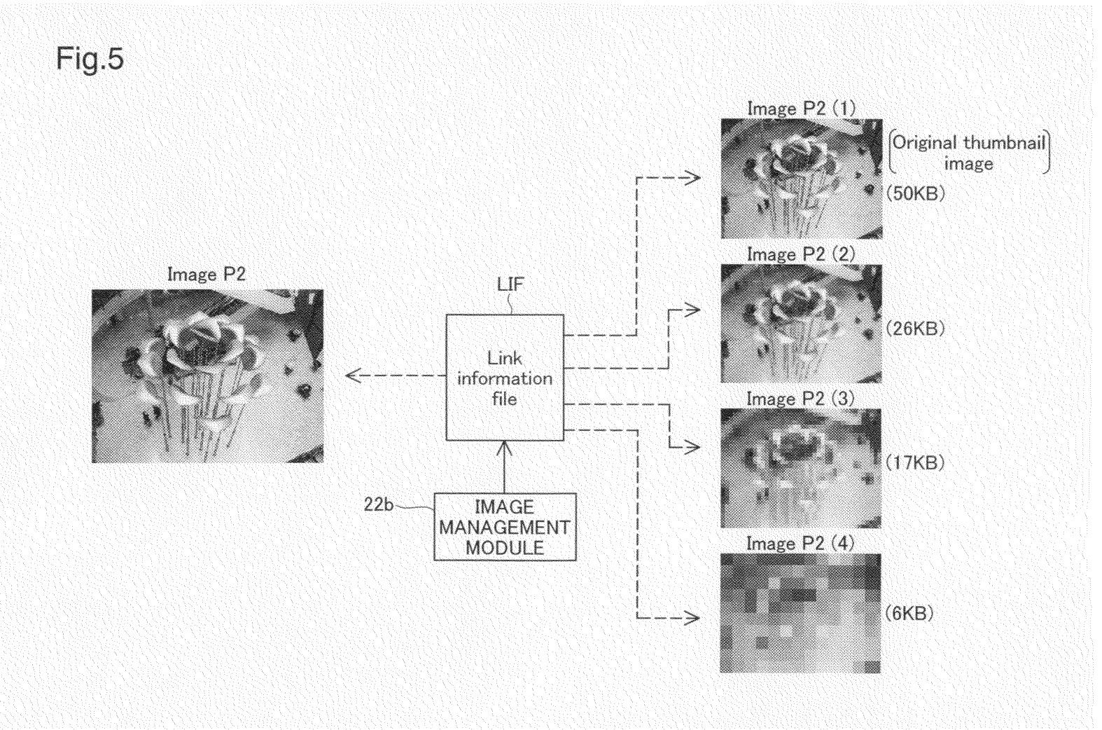

FIG. 5 is an explanatory drawing showing an example of a speed correlated image group generated at step S205. In FIG. 5, the image at the left hand side is the image P2 stored in the memory card MC, and the four images P2(1) to P2(4) at the right hand side are the speed correlated image group for the image P2. The speed correlated image generator 22a decompresses the thumbnail compression image for the image P2 to generate these images P2(1) to P2(4). In the inverse quantization of the spatial frequency components of the compressed image data during the decompression process, the speed correlated image generator 22a sets a fixed value of 0 at specific AC components, rather than the ordinary inverse quantization using an inverse quantization table.

In specific terms, for the image P2(4), of all the AC components, the AC components other than the first horizontal and vertical AC components are replaced with 0. Similarly, for the images P2(3) and P2(2) as well, part of the AC components are replaced with 0. Note that the number of AC components for which replacement is done with 0 is smaller in the order of image P2(4), image P2(3), and image P2(2). Then, for the image P2(1), none of the AC components are replaced with 0, and therefore the image P2(1) is the original thumbnail image itself. Note that with an image generated in this way, the image P2(1) has the highest image quality, and thereafter, the image quality is lower in steps in the sequence of image P2(2), P2(3), and P2(4). The speed correlated image generator 22a, similarly for the other images P1, P3, and the like as well, generates four speed correlated images of respectively different image quality.

The speed correlated image generator 22a may again compress using the JPEG method the speed correlated image groups generated in this way and stores them in the RAM 25. Note that for the image P2(1), it is also possible to store the thumbnail compressed image as is as the compressed images of the image P2(1) in the RAM 25 without executing the aforementioned decompression and recompression. As shown in FIG. 5, the image data size obtained by compressing each speed correlated image is larger the higher the image quality of the image obtained by compressing the speed correlated image. Then, the image management module 22b stores in the RAM 25 a link information file LIF, described in XML (eXtensible Markup Language), indicating the corresponding relationship of the compressed image data files of the speed correlated images P2(1) to P2(4), and the compressed image data file of the original image P2.

Note that as is described later, at the printer 100, of the four speed correlated image groups Pi(1) to Pi(4) of the i-th image Pi, the highest image quality image Pi(1) is used as a stop mode image which is displayed when the rotation speed of the tracking wheel 45 is at a stopped level. Also, the second highest image quality image Pi(2) is used as a low speed image which is displayed when the rotation speed is at low speed level, the third highest image quality image Pi(3) is used as a high speed image which is displayed when the rotation speed is at high speed level, and the lowest image quality image Pi(4) is used as a super high speed image which is displayed when the rotation speed is at super high speed level.

Returning to FIG. 4, the image management module 22b specifies the compressed image data of the stop mode image of the leading image or the first image in the memory card MC with reference to the link information file LIF, decompresses this compressed image data, and stores the obtained stop mode image in the frame memory 41. Then, the display control module 22c displays the stop mode image of the leading image stored in the frame memory 41 on the liquid crystal panel 42 in step S210.

Next, the image management module 22b monitors the speed level signals SLS output from the frequency filter 46, and determines whether or not there are changes in the rotation speed of the tracking wheel 45 in step S215. At the beginning of the image display process, the frequency filter 46 outputs a speed level signal SLS indicating “stop,” but when the user rotates the tracking wheel 45, the frequency filter 46 outputs a speed level signal SLS indicating any of the levels “low speed,” “high speed,” or “super high speed” according to the rotation speed of the tracking wheel 46 as well as the rotation direction signal RDS. In this case, the image management module 22b determines that there is a change in the rotation speed of the tracking wheel 45.

In step S215, when it is determined that there is a change in the rotation speed of the tracking wheel 45, the image management module 22b selects an image to be displayed based on the speed level signal SLS and the rotation direction signal RDS in step S220.

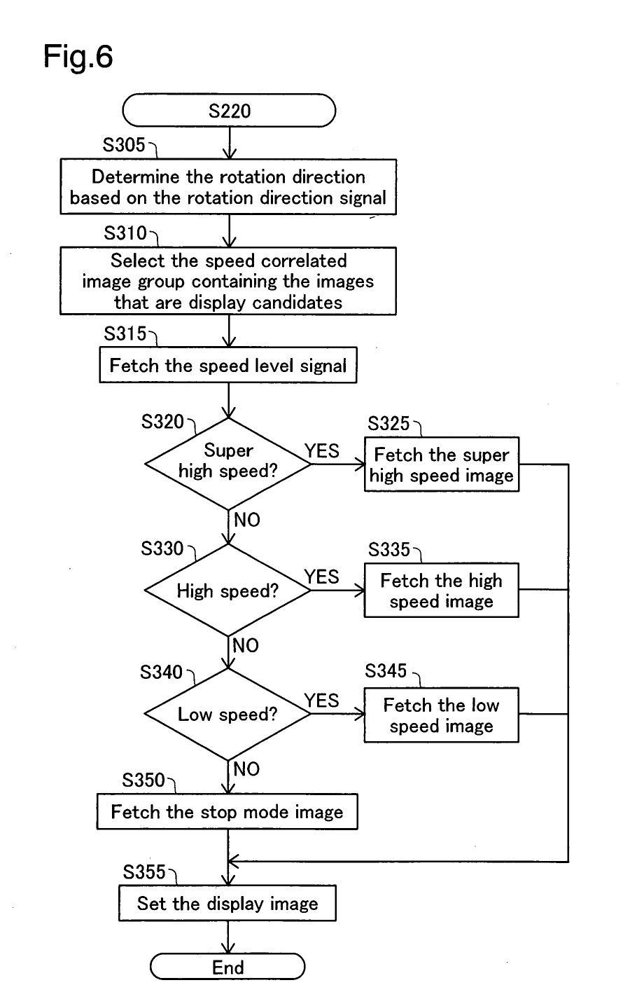

FIG. 6 is a flow chart showing the details of the step S220 shown in FIG. 4. In step S305, the image management module 22b (FIG. 2) determines the rotation direction of right turn or left turn based on the rotation direction signal RDS. In step S310, the image management module 22b selects a speed correlated image group containing images that are display candidates based on the current display image and rotation direction. In step S315, the image management module 22b fetches the speed level signal SLS. In step S320, the image management module 22b determines whether or not the rotation speed is the super high speed based on the fetched speed level signal SLS. Then, when it is determined that the rotation speed is super high speed, the super high speed image is selected from among the speed correlated image group selected in step S310, and the compressed image data of this image is fetched from the RAM 25 in step S325. Similarly, the image management module 22b determines whether or not the rotation speed is high speed in step S330, and when the rotation speed is determined to be high speed, the compressed image data of the high speed image is fetched from the RAM 25 in step S335. Also, the image management module 22b determines whether or not the rotation speed is low speed in step S340, and when the rotation speed is determined to be low speed, the compressed image data of the low speed image is fetched from the RAM 25 in step S345. Then, when the image management module 22b determines that the rotation speed is none of the super high speed, high speed, and low speed, the rotation speed is regarded as being stopped, and the compressed image data of the stop mode image is fetched from the RAM 25 in step S350. In step S355, the image management module 22b sets the image of the compressed image data fetched at step S325, step S335, step S345, or step S350 as the display image.

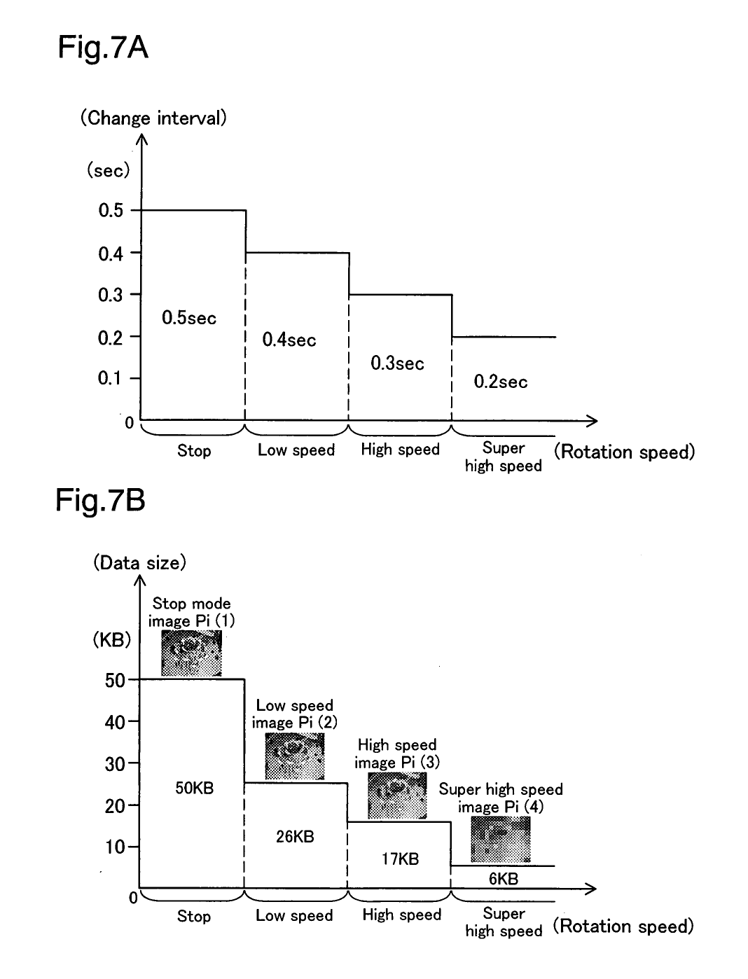

FIG. 7A shows the correlation between the rotation speed of the tracking wheel 45 and the change interval of the displayed images, and FIG. 7B shows the correlation between the rotation speed of the tracking wheel 45 and the display image data size. Note that with FIGS. 7A and 7B, the rotation speed is divided into four speed levels of “stop”, “low speed”, “high speed”, and “super high speed.”

As shown in FIG. 7A, at the printer 100, the display image changing interval is set according to the rotation speed of the tracking wheel 45. For example, when the rotation speed is in a range correlating to the “stop” level, the image displayed on the liquid crystal panel 42 is changed every 0.5 seconds. Then, as the rotation speed of the tracking wheel 45 becomes faster, the display image changing interval lowers to 0.4 seconds, 0.3 seconds, and 0.2 seconds. In other words, as the rotation speed of the tracking wheel 45 becomes faster, the changing speed of the display images becomes faster.

With this printer 100, images of a smaller data size are displayed at a shorter changing interval. As shown in FIG. 7B, when the rotation speed of the tracking wheel 45 is in a range correlating to the “stop” level, the stop mode image Pi(1) with the largest data size is displayed. The low speed image Pi(2) with the second largest data size is displayed when the rotation speed correlates to the “low speed” level, the high speed image Pi(3) with the third largest data size is displayed when the rotation speed correlates to the “high speed” level, and the super high speed image Pi(4) with the smallest data size is displayed when the rotation speed correlates to the “super high speed” level.

In step S225 of FIG. 4, when the display image is set, the image management module 22b decompresses the compressed image data of the selected speed correlated image and stores the decompressed image data in the frame memory 41, and the display control module 22c displays this speed correlated image on the liquid crystal panel 42 in step S225. Then, the image management module 22b determines whether a quit operation has been done by the user in step S230. Examples of the quit operation include a user's operation of selecting an image subject to printing with the operating unit 44, and another operation of pressing down the cancel button (not illustrated) of the operating unit 44. When it is determined that the quit operation is not done, the process returns to the step S215, and the processes of steps S215 to step S230 are executed repeatedly until a quit operation is done.

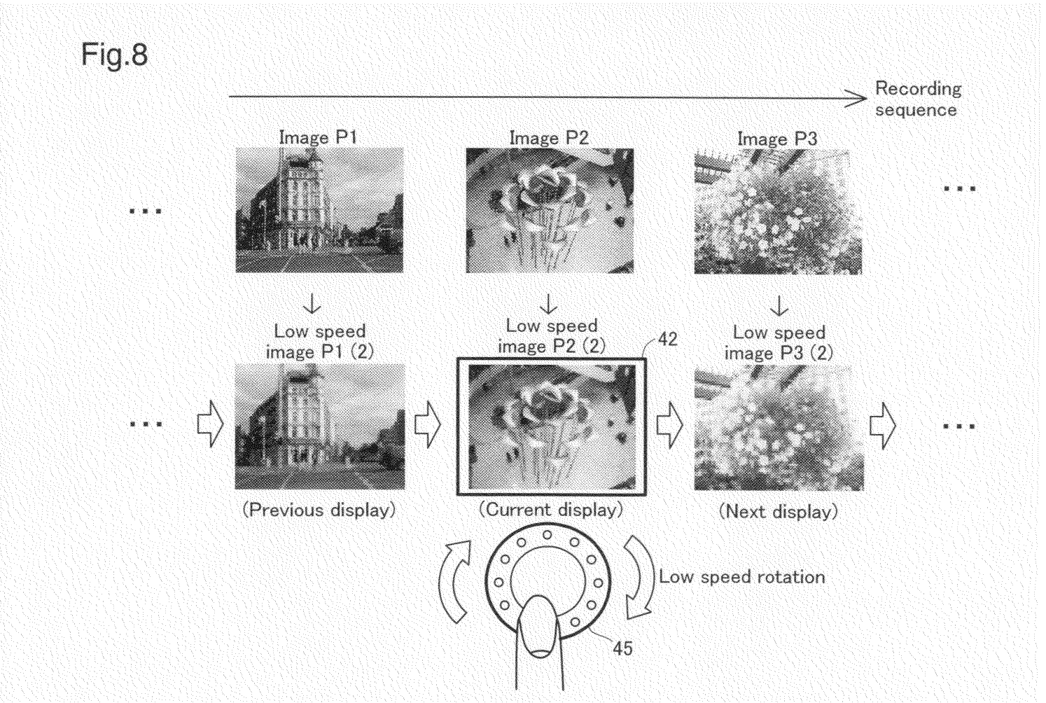

FIG. 8 is an explanatory drawing typically showing the state of the speed correlated images being displayed on the liquid crystal panel 42 for the first embodiment. In a state with the low speed image P1(2) of the image P1 being displayed on the liquid crystal panel 42, when the speed level signal SLS indicating low speed and the rotation direction signal RDS indicating “right turn” are received from the frequency filter 46, the image management module 22b sets the low speed image P2(2) of the image P2 as the next display image. Therefore, as shown in FIG. 8, on the liquid crystal panel 42, the low speed image P2(2) is displayed after the image P1(2). When the user further rotates the tracking wheel 45 to the right with the rotation speed correlating to this “low speed” level kept as is, the image management module 22b sets the low speed image P3(3) of the image P3 as the next display image. By working in this way, the low speed images P1(2), P2(2), and P3(2) are displayed in sequence on the liquid crystal panel 42.

As described above, in the first embodiment, four speed correlated images Pi(1) to Pi(4) are generated for each image, and a speed correlated image of the smaller data size is selected to be displayed as the rotation speed of the tracking wheel 45 becomes higher. Since the compressed image data with a smaller data size is decompressed in a shorter time, they are displayed on the liquid crystal panel 42 more quickly. Therefore, when the rotation speed of the tracking wheel 45 is faster, the display images are changed in a shorter time, thereby realizing high speed image display changes. Accordingly the user can view high image quality images by slowly rotating the tracking wheel 45, while the user can achieve more quick change of display images by quickly rotating the tracking wheel 45.

### B. Second Embodiment

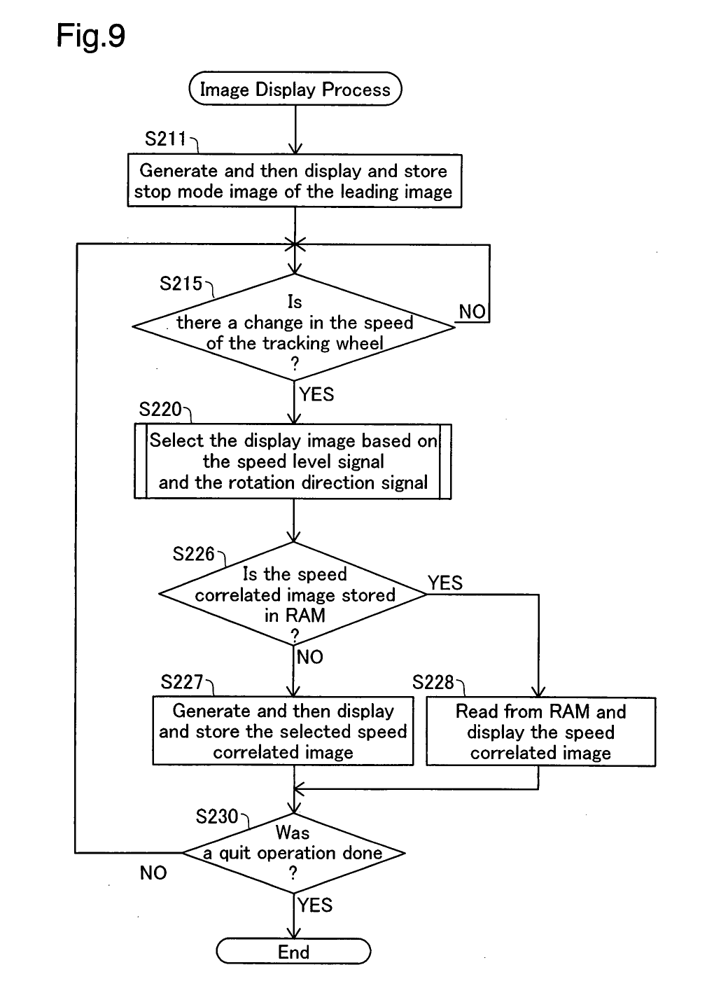

FIG. 9 is a flow chart showing the image display process for the second embodiment. In the second embodiment, the step S205 and step S210 of FIG. 4 are replaced with step S211, and the step S225 of FIG. 4 is replaced with steps S226 to S228, and the remainder is the same as with the first embodiment. While the first embodiment is arranged such that the speed correlated images are generated in advance for each of the images stored in the memory card MC and these are stored in the RAM 25, the second embodiment is arranged such that a speed correlated image is generated after it is selected as an image to be displayed. Note that the constitution of the printer for the second embodiment is the same as the printer 100 with the first embodiment.

When the image display process shown in FIG. 9 starts, the speed correlated image generator 22a reads the image data of the leading image from the memory card MC into the RAM 25, generates a stop mode image for the leading image, and stores the same in the frame memory 41. The generated stop mode image is also compressed and stored in the RAM 25. Then, the display control module 22c displays this stop mode image on the liquid crystal panel 42 in step S211. After a speed correlated image is selected as an image to be displayed in the steps S215 and S220, the image management module 22b determines whether or not the compressed image data for the selected speed correlated image is already stored in the RAM 25 in step S226.

When it is determined that the compressed image data of the selected speed correlated image is not stored in the RAM 25, the speed correlated image generator 22a reads the image data from the memory card MC, generates the selected speed correlated image and stores it in the frame memory 41, and also compresses this speed correlated image and stores it in the RAM 25. Then, the display control module 22c displays the speed correlated image on the liquid crystal panel 42 in step S227. Note that the method of generating the speed correlated image is the same as that of the first embodiment.

When, on the other hand, it is determined that the compressed image data of the speed correlated image selected at step S226 is already stored in the RAM 25, the image management module 22b reads this compressed image data from the RAM 25 and performs decompression processing, and stores the decompressed image data in the frame memory 41. Then, the display control module 22c displays the speed correlated images on the liquid crystal panel 42 in step S228. Next, the same as with the first embodiment, step S230 is executed, and until there is a quit operation by the user, the processes of the steps S215 to S230 are repeatedly executed.

When the speed correlated image generator 22a generates the speed correlated image, specific AC components are replaced with a fixed value of “0”, rather than being subject to the inverse quantization using an inverse quantization table. Here, by replacing with “0,” it is possible to execute the decompression in a shorter time than when performing the inverse quantization, and the generation time of the speed correlated images P2(4), P2(3), P2(2), and P2(1) will be shorter in this order. Therefore, when the rotation speed of the tracking wheel 45 is faster, it is possible to generate the speed correlated images and display them in a shorter time after being selected as the display image.

Also, once speed correlated images are generated, their compressed image data are stored and maintained in the RAM 25. Therefore, after the compressed image data are stored in the RAM 25, they are readily read out from the RAM 25 in response to the rotation speed of the tracking wheel 45 in the same way as with the first embodiment. Thus it is possible to change the display images in a shorter time as the rotation speed of the tracking wheel 45 becomes faster, thereby realizing high speed image display changes.

### C. Third Embodiment

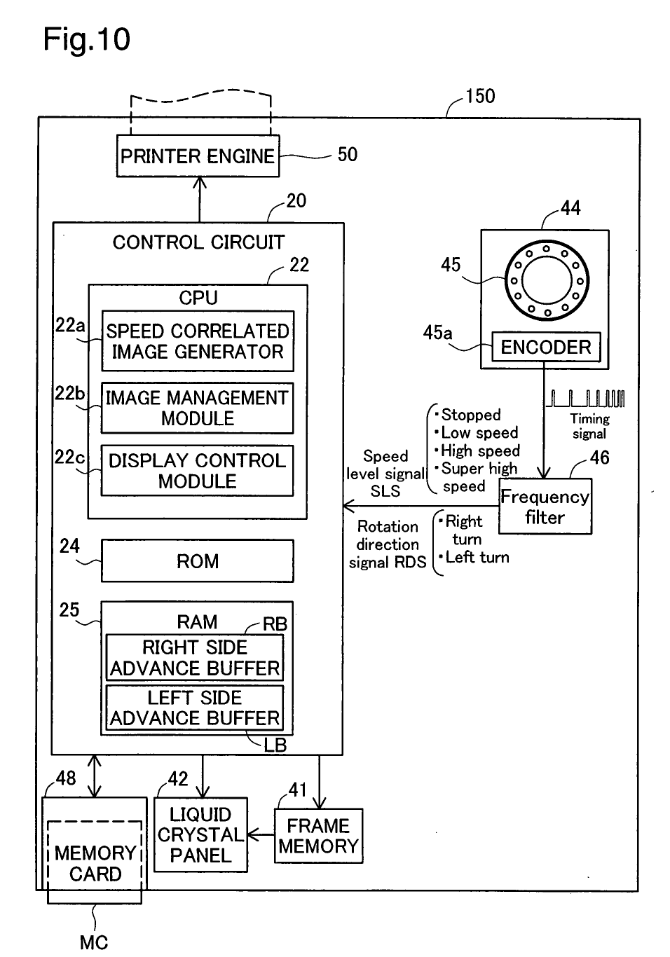

FIG. 10 is a block diagram showing the internal structure of the printer of the third embodiment. This printer 150 is different from the printer 100 shown in FIG. 2 in that a right side advance buffer RB and a left side advance buffer LB are secured in advance in the RAM 25, and the remainder of the constitution is the same as that of the printer 100.

With the second embodiment described above, a speed correlated image selected as the display image in step S220 is generated after it is determined that the speed correlated image is not stored in the RAM 25. Therefore, if the tracking wheel 45 is being stopped and some stop mode image is being displayed in the liquid crystal panel 42, user's new operation to rotate the tracking wheel 45 will result in reading of the image data of the next image and generation of a speed correlated image for the next image. Because of this, when the data reading time from the memory card MC or the decompression time of the compression image data is relatively long, the waiting time will be relatively long until the speed correlated image for the next image is displayed. In light of this, with the third embodiment, when one stop mode image is selected as an image to be displayed, the image data from which the selected stop mode image is to be generated is read from the memory card MC, and the image data of its adjacent images are also read from the memory card MC. The speed correlated images for the adjacent images are then generated in advance, whereby the wait time will be shorter until display of the speed correlated image for the adjacent images in response to the user's operation of the tracking wheel 45.

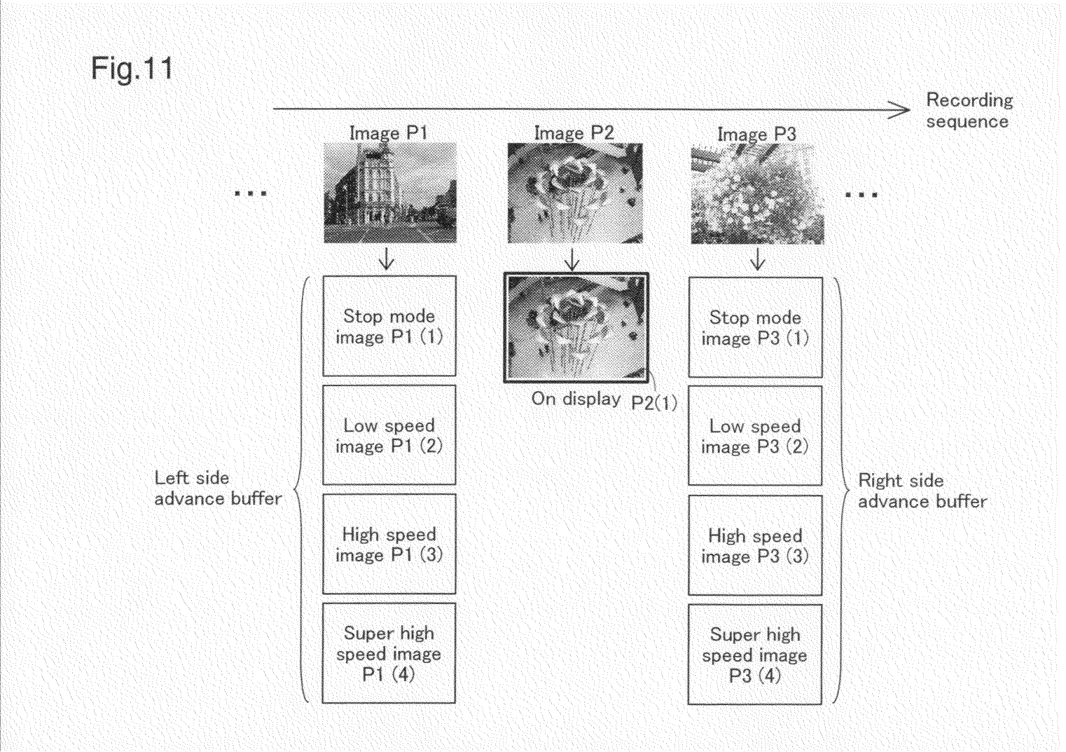

FIG. 11 is an explanatory drawing typically showing the speed correlated images generated with the third embodiment. When the stop mode image P2(1) of the image P2 is set as the display image and it is determined that the compressed image data of the stop mode image P2(1) is not stored in the RAM 25, in addition to the image data of the image P2 that is the source of the selected speed correlated image, the image management module 22b reads and stores in RAM 25 the image data of the left adjacent image P1 and the image data of the right adjacent image P3 as well.

Then, the speed correlated image generator 22a generates the stop mode image P2(1) based on the image P2 thumbnail image data and displays it on the liquid crystal panel 42. The speed correlated image generator 22a also generates all the speed correlated images P1(1) to P1(4) for the left adjacent image P1, and stores them in the left side advance buffer LB, and also generates all the speed correlated image P3(1) to P3(4) for the right adjacent image P3 and stores them in the right side advance buffer RB.

When the user starts rotating the tracking wheel 45, the image management module 22b reads a speed correlated image according to the rotation speed from the left side advance buffer LB or the right side advance buffer RB, and stores the same in the frame memory 41. Thus it is possible to display the speed correlated image according to the rotation direction and the rotation speed of the tracking wheel 45. Compared to a constitution that reads the image data from the memory card MC and generates the speed correlated image after the speed correlated image is selected as the display image, it is possible to shorten the time from the start of rotating the tracking wheel 45 until display of the speed correlated image.

The speed correlated images for both the left and right adjacent images are preferably generated because in the stopped state the user may rotate the tracking wheel 45 in either direction. Also, the generation in advance of all the speed correlated images makes it possible to readily display any one of the four types of speed correlated images in response to any rotation speed of the tracking wheel 45.

### D. Fourth Embodiment

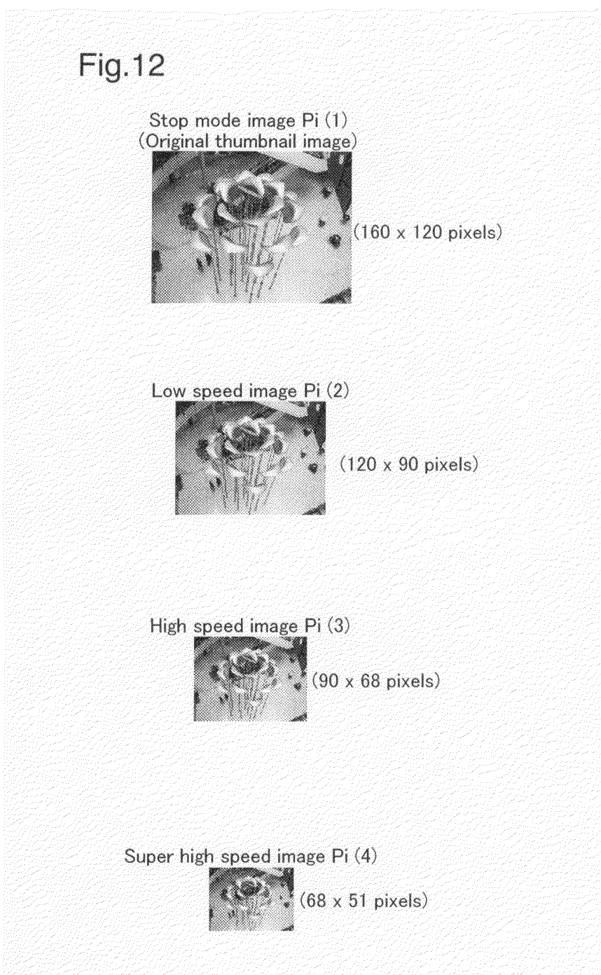

FIG. 12 is an explanatory drawing showing the speed correlated images with the fourth embodiment. With the first through third embodiments described above, the images generated as the speed correlated images all have the same image size (pixel count) as shown in FIG. 5. In contrast to this, the speed correlated images Pi(1) to Pi(4) with this embodiment are images for which the original thumbnail image Pi(1) has been reduced, and they have mutually different image sizes.

In specific terms, as shown in FIG. 12, the stop mode image Pi(1) is the same as the original thumbnail image shown in FIG. 5. Meanwhile, the low speed image Pi(2) is reduced in size from the original thumbnail image of 160×120 pixels with interpolation to have an image size of 120×90 pixels, and similarly, the high speed image Pi(3) is generated to have an image size of 90×68 pixels, and the super high speed image Pi(4) is generated to have an image size of 68×51 pixels.

The data sizes of the compressed image data for these four speed correlated images Pi(1) to Pi(4) are gradually smaller in this order with the stop mode image Pi(1) being the largest, followed by the low speed image Pi(2), the high speed image Pi(3), and the super high speed image Pi(4). Here, images with smaller data size can be expanded in a shorter time, so it is possible to display them on the liquid crystal panel 42 faster. As is the case with the first through third embodiments, it is possible to change the display images in a shorter time in response to a faster rotation speed of the tracking wheel 45, thereby realizing higher speed image display change.

### E. Variation Examples

Note that among the elements and features of the aforementioned embodiments, the elements and features which are not recited in the independent claims are optional, and can be omitted as appropriate. Also, this invention is not limited to the aforementioned embodiments or aspects, and it is possible to implement various aspects in a scope that does not stray from the key points, with the following kinds of variations possible, for example.

### E1. Variation Example 1

Although the four speed correlated images Pi(1) to Pi(4) corresponding to the four speed levels are used in the first to fourth embodiments, the number of speed correlated images may be set to any number of 2 or more. Also, with the first through third embodiments, the speed correlated images are generated by expanding the compressed image data of the original thumbnail image while replacing with “0” part of the AC components. Also, with the fourth embodiment, the speed correlated images are generated by reducing the original thumbnail images. The speed correlated images of the present invention are not limited to these images, but they are acceptable as long as the speed correlated images for faster rotation speeds (or faster display image changing speeds) will be displayed in a shorter time.

For example, in the case that two speed correlated images are used corresponding to two levels of high speed and low speed, it is also possible to use a constitution wherein the expanded or decompressed image is stored as the high speed image in the RAM 25, and the compressed image is stored as the low speed image in the RAM 25. With this constitution, in contrast to the first through fourth embodiments, when rotating the tracking wheel 45 at a higher speed, the expanded image having a larger data size than the compressed image is selected as the speed correlated image. However, since the high speed image is already expanded, the high speed image will be displayed on the liquid crystal panel 42 in a shorter time than the low speed image for which the expansion process is performed.

It is also possible to have a constitution for which the high speed images are produced by decreasing the color components of the low speed images. For example, one possible constitution will be with full color images as the low speed images and monochromatic images as the high speed images. Even with this constitution, the time required to make a display format image with expansion of the monochromatic images can be shorter than the time required to make a display format image with expansion of the full color images which are low speed images. As a result, it is possible to display the high speed images on the liquid crystal panel 42 in a shorter time than the low speed images.

### E2. Variation Example 2

For the timing of generating the high speed correlated images, with the first embodiment described above, the speed correlated images are generated for all the images in the initial step at which the image display process starts in step S205. Also, with the second embodiment, each speed correlated image is generated only after the speed correlated image is selected as the display image. Also, with the third embodiment, a speed correlated image is generated after the speed correlated image is selected as the display image, and in addition all the speed correlated images for the adjacent images are generated. However, the present invention is not limited to these constitutions. For example, it is also possible to use the idle time during which the tracking wheel 45 is not rotating to generate all the speed correlated images in sequence from the leading image.

### E3. Variation Example 3

With the third embodiment described above, when the stop mode image is selected as the display image, speed correlated images are generated for the adjacent images, and they are stored in the left side advance buffer LB and the right side advance buffer RB. However, the speed correlated images for the adjacent images may be generated and stored in the left side advance buffer LB and the right side advance buffer RB when other speed correlated images such as the low speed image or the like is selected as the display image. Also, with the third embodiment, all the speed correlated images are generated for the adjacent images, but it is also possible that only some but not all of the speed correlated images are generated for the adjacent images.

In specific terms, for example, when the low speed image P1(2) of the image P1 shown in FIG. 8 is being displayed in the liquid crystal panel 42, and when the low speed image P2(2) of the image P2 is set as the next image to be displayed, it is possible to have the image data of the image P2 read and the low speed image P2(2) generated and displayed, and to also have the image data of the image P3 read, the low speed image P3(2) generated, and have its compressed image data stored in the right side advance buffer RB. By working in this way, when the user keeps the same rotation speed and rotates the tracking wheel 45 in the same direction, it is possible to shorten the time until the subsequent speed correlated image is displayed on the liquid crystal panel 42. In this example, it is also possible to store the low speed image P1(2), which is being displayed, into the left side advance buffer LB. By working in this way, even when the user keeps the same rotation speed and rotates the tracking wheel 45 in the opposite direction, it is possible to shorten the time until the speed correlated image is displayed on the liquid crystal panel 42.

### E4. Variation Example 4

With the first to fourth embodiments described above, the user interface for specifying the change direction, change speed or the like of the images displayed on the liquid crystal panel 42 is realized as the tracking wheel 45, but the present invention is not limited to this. For example, it is also possible to use two buttons, such as left and right buttons, corresponding respectively to the left and right directions as the user interface. Specifically, it is also possible to have the user specify the change direction by pressing down either of the left or right buttons. It is also possible that a faster change speed is specified by continuing to press down the left or right button for a longer time. Also, this is not limited to these left and right buttons, but it is also possible to use a pointing device such as a track pad or the like used with notebook type personal computers as the user interface.

### E5. Variation Example 5

With the third embodiment described above, when a speed correlated image is selected as the display image, together with the selected speed correlated image, the speed correlated images for the adjacent images are also generated, but instead of generating the speed correlated images for the adjacent images, it is possible to construct the apparatus such that the image data for the adjacent images are read to the RAM 25 without advancing to the generation of their speed correlated images. By working in this way as well, compared to a constitution whereby the image data of the adjacent images are read from the memory card MC after rotation of the tracking wheel 45 is started, it is possible to shorten the time until display of the speed correlated images from the start of rotation of the tracking wheel 45.

### E6. Variation Example 6

In the first to fourth embodiments, the image display device according to the present invention is realized as a printer, but the present invention may be realized as other devices. The image display device according to the present invention may be any devices or apparatuses as long as they can sequentially display a plurality of images; the examples include a digital still camera, a dedicated device for viewing electronic images, a photo viewer, a mobile phone with a digital still camera, a mobile digital music player.

### E7. Variation Example 7

With the first to fourth embodiments, it is possible to replace part of the constitution realized using hardware with software, and conversely, it is also possible to replace part of the constitution realized using software with hardware. For example, part of the functions of the speed correlated image generator 22a can also be constituted with a hardware circuit.

What is claimed is:

1. An image display device for displaying a plurality of original images aligned in a specified sequence, comprising:
a display unit configured to display an image;
a display control module configured to cause the display unit to display a display image of an original image selected among the plurality of images while changing the image selection according to the specified sequence; and
a user interface unit configured to allow a user to perform operations for changing the image selection,
wherein a plurality of changing speed levels are correlated to the operation of the user interface unit, and
the display control module is configured to use a plurality of speed correlated images correlated respectively to the plurality of changing speed levels as the display images to be displayed on the display unit for each of the plurality of original images, the speed correlated images being constructed such that higher-speed correlated images correlated to higher changing speed levels are displayed in a shorter time.

2. The image display device in accordance with claim 1, further comprising:
a storage unit configured to store the plurality of original images; and
an image generator configured to read a selected original image from the storage unit, and to generate the speed correlated images of the selected original image correlated to the changing speed levels,
wherein the image generator reads adjacent original images that are aligned adjacent to the selected original image in the specified sequence, as well as the selected original image from the storage unit.

3. The image display device in accordance with claim 1, wherein
the speed correlated images are compressed by a specific compression algorithm, and the speed correlated images are constructed such that compressed image data of higher-speed correlated images correlated to higher changing speed levels have smaller data size.

4. The image display device in accordance with claim 3, wherein
the speed correlated images have an identical image size, and the speed correlated images are constructed such that compressed image data of higher-speed correlated images correlated to higher changing speed levels have fewer non-zero high frequency AC components.

5. The image display device in accordance with claim 1, wherein
the user interface unit includes a rotating operating unit, and
the user interface unit determines a changing speed level from the rotation speed of the rotating operating unit.

6. A method of displaying a plurality of original images aligned in a specified sequence according to operation of a user interface unit, comprising the steps of:
(a) setting in advance a plurality of changing speed levels correlated to the operation of the user interface unit;
(b) correlating a plurality of speed correlated images respectively to the plurality of changing speed levels as display images to be displayed for each of the plurality of original images, the speed correlated images being constructed such that higher-speed correlated images correlated to higher changing speed levels are displayed in a shorter time; and
(c) displaying a display image of an original image selected among the plurality of images while changing the image selection according to the specified sequence in response to the operation of the user interface unit.

7. The method in accordance with claim 6, wherein the step (c) includes the step of:
reading a selected original image from a storage unit storing the plurality of original images; and
generating the speed correlated images of the selected original image correlated to the changing speed levels,
wherein the step of reading a selected original image includes reading adjacent original images that are aligned adjacent to the selected original image in the specified sequence, as well as the selected original image from the storage unit.

8. The method in accordance with claim 6, wherein
the speed correlated images are compressed by a specific compression algorithm, and the speed correlated images are constructed such that compressed image data of higher-speed correlated images correlated to higher changing speed levels have smaller data size.

9. The method in accordance with claim 8, wherein
the speed correlated images have an identical image size, and the speed correlated images are constructed such that compressed image data of higher-speed correlated images correlated to higher changing speed levels have fewer non-zero high frequency AC components.

10. The method in accordance with claim 6, wherein
the user interface unit includes a rotating operating unit, and
a changing speed level is determined from the rotation speed of the rotating operating unit.
